(19) United States
(12) Patent Application Publication
(10) Pub. No.: US 2007/0264478 A1
(43) Pub. Date: Nov. 15, 2007

(54) Substrate structures for display application and fabrication methods thereof

(75) Inventors: Jane-Hway Liao, Hsinchu County (TW); Wei-Ling Lin, I-Lan Hsien (TW); Yu-Yang Chang, Tainan (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/525,403

(22) Filed: Sep. 22, 2006

(30) Foreign Application Priority Data
May 12, 2006 (TW) TW95116883

(51) Int. Cl. G03G 7/00

(52) U.S. Cl. 428/195.1

(57) ABSTRACT

Substrate structures for display devices and fabrication methods thereof The substrate structure comprises a substrate, an interfacial layer disposed on the substrate, and a patterned paste layer applied on the interfacial layer, wherein a contact angle of the interface between the patterned paste layer and the interfacial layer exceeds 35 degrees.

### BACKGROUND OF THE INVENTION

1. Field of the Invention

The invention relates to display devices and fabrication methods thereof, and in particular, to substrate structures for display applications and fabrication methods thereof.

2. Description of the Related Art

Field emission display (FED) devices are panelized conventional cathode ray tube (CRT) displays. By using screen printing technology, large scale FED devices can be achieved. Conventional large scale FED devices have many advantages such as low volume, light weight, low power consumption, excellent image quality, and applicability to a variety of electronic and communication devices. Carbon nanotube or other nano-scale field emitters have benefits such as low threshold field, high emission current density, and high stability due to lower threshold voltage, higher light efficiency, higher viewing angle, and lower power consumption.

FIG. 1 is cross section of a conventional field emission display device. In FIG. 1, a field emission display device 10 comprises a pair of opposing parallel substrates 11 and 12. The lower substrate 11 comprises a cathode electrode, gate line and electron field emitter 13 thereon. The upper substrate 12 comprises an anode electrode 14. A phosphor layer 15 is applied on the anode electrode 14. When a bias is applied between the cathode and anode electrodes, electrons emit from field emitter (or cathode electrode) toward the anode electrode and then bombard phosphor layer 15 exciting visible light. Large scale FED devices can be used as a back light, referred to as field emission back light unit (FE-BLU). Conventional FE-BLU and FED, however, require a lithographic process to achieve high resolution patterned electrodes. If the electrodes can be patterned by screen printing, intricate exposure apparatus, development apparatus and consumption of developer can be saved, thus reducing production cost.

FIGS. 2A-2D are cross sections showing the lithographic fabrication steps of a conventional FED device. Referring to FIG. 2A, a lower substrate 22 such as transparent glass substrate is provided. A conductive layer 21 is deposited on the lower substrate 11.

Referring to FIG. 2B, the conductive layer 21 is patterned by lithography. For example, a photo resist (not shown) is applied on the conductive layer 21. A mask 51 is disposed on the photo resist exposed under a UV light source. After developing, the conductive layer 21 is etched and patterned, as shown in FIG. 2C. The patterned conductive layer comprises a cathode pattern 24 and a gate line pattern 36.

Referring to FIG. 2D, a carbon nanotube field emitter 25 is subsequently formed on the cathode pattern 24. For example, a carbon nanotube paste is screen printed on the cathode pattern 24. After photo spacers and ribs are formed on the lower substrate, the lower substrate and upper substrate are assembled, completing fabrication of the FED device.

Conventional screen printing technology uses a squeegee to press paste through a patterned screen, thereby transferring the pattern to a substrate. Thick film screen printing technology is a well-developed technology for reducing cost and mass production in conventional electronic industries. Resolution of thick film screen printing, however, is limited by screen meshes and spread of patterned paste, hindering high resolution printing. For example, referring to FIG. 3, a paste pattern 120 is transferred onto a substrate 110 by screen printing. Since the interface between the paste pattern 120 and the substrate 110 includes low contact angle a, spread of the paste pattern 120 occurs leading to low resolution. More specifically, the contact angle between cathode paste pattern and the glass substrate is very small, thus spread of the cathode paste pattern on the glass substrate deteriorates. Further, if the viscosity of the paste is low, the printed pattern line width can be twice as wide as the pattern line width on the screen mesh, reducing line width resolution. Thus, eliminating paste spread to improve line width resolution from several hundreds of micrometers to several tens of micrometers in resolution is desirable.

### BRIEF SUMMARY OF THE INVENTION

Accordingly, substrate structures for display applications are provided by interposing an interfacial layer between the paste pattern and the substrate to prevent spread of the paste pattern and to achieve high density, high resolution FED devices.

The invention provides a substrate structure, comprising: a substrate, an interfacial layer disposed on the substrate, and a patterned paste layer applied on the interfacial layer, wherein a contact angle of the interface between the patterned paste layer and the interfacial layer exceeds 35 degrees.

The invention further provides a substrate structure, comprising a substrate, an interfacial layer disposed on the substrate, a patterned paste layer applied on the interfacial layer, a dielectric layer disposed on the patterned paste layer, and a gate electrode disposed on the dielectric layer, wherein a contact angle of the interface between the patterned paste layer and the interfacial layer exceeds 35 degrees.

The invention further provides a substrate structure, comprising a substrate, an interfacial layer disposed on the substrate, a patterned paste layer applied on the interfacial layer, a patterned insulating wall structure disposed on the interfacial layer dividing a plurality of pixel regions, and a fluorescent layer disposed in each pixel region covering the patterned paste layer, wherein a contact angle of the interface between the patterned paste layer and the interfacial layer exceeds 35 degrees.

The invention still further provides a method of fabricating a substrate structure. A substrate is provided. A surface treatment process is performed on the substrate to change the polarity of the substrate. A patterned paste layer is applied on the treated surface of the substrate, wherein a contact angle of the interface between the patterned paste layer and the treated surface of the substrate exceeds 35 degrees.

### BRIEF DESCRIPTION OF THE DRAWINGS

The invention can be more fully understood by reading the subsequent detailed description and examples with references made to the accompanying drawings, wherein:

FIG. 1 is cross section of a conventional field emission display device;

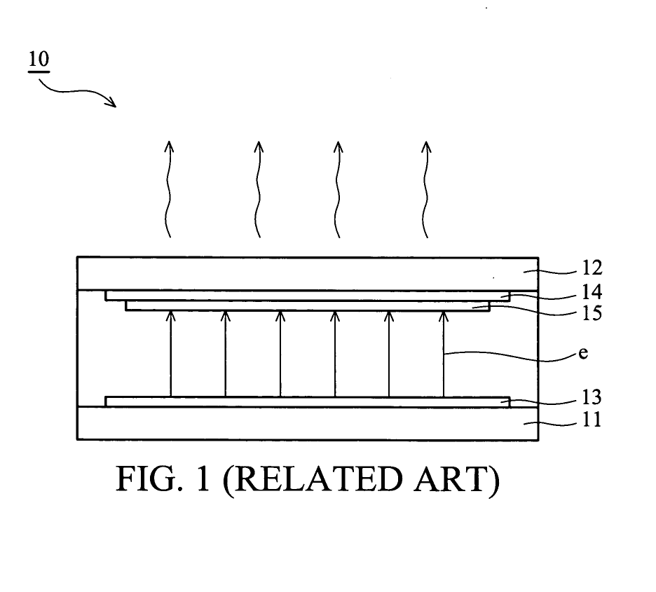

FIGS. 2A-2D are cross sections showing the lithographic fabrication steps of a conventional FED device;

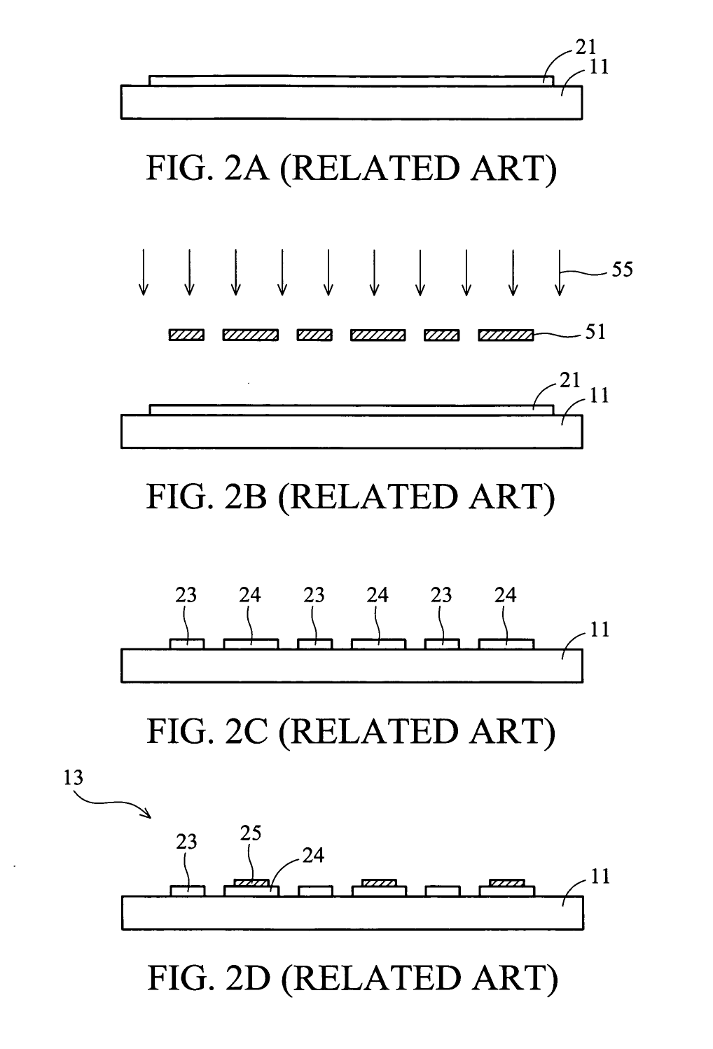

FIG. 3 is a schematic view of a paste pattern transferred onto a substrate by screen printing which includes a low contact angle α leading to low resolution;

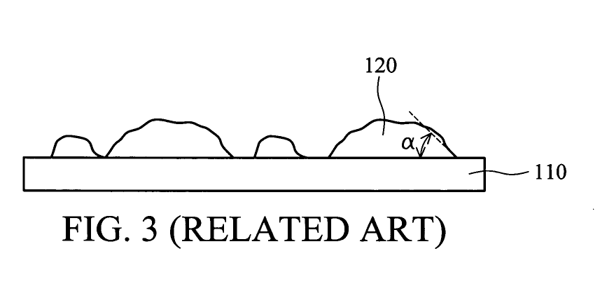

FIGS. 4A-4C are cross sections showing fabrication steps of a substrate structure for a field emission back light unit (FE-BLU) according to an embodiment of the invention;

FIG. 5 is a cross section of a CNT-FED device according to an exemplary embodiment of the invention;

FIGS. 6A-6C are cross sections showing fabrication steps of a substrate structure for a plasma display panel (PDP) according to another embodiment of the invention; and

FIG. 7 is a cross section of a PDP device according to another exemplary embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention is directed to a substrate structure for display applications. An interfacial layer is disposed on a substrate to prevent spread of electrode paste patterns on the substrate. The interfacial layer can improve surface tension of the electrode paste and reduce wettability between the electrode paste patterns and the substrate. The contact angle between the electrode paste patterns and the interfacial layer is preferably greater than 35°, more preferably greater than 40°. Since the interfacial layer can prevent spread of electrode paste, the contact angle between the electrode paste pattern and the interfacial layer is greater the contact angle between the electrode paste pattern and the substrate. Compared with printing an electron paste pattern of 50 μm line width and 50 μm line interval on a glass substrate, the contact angle can increase by at least 15° due to addition of the interfacial layer. Moreover, a substrate structure with a high resolution electron paste pattern of 17 μm line width and 83 μm line interval can further achieved due to addition of the interfacial layer.

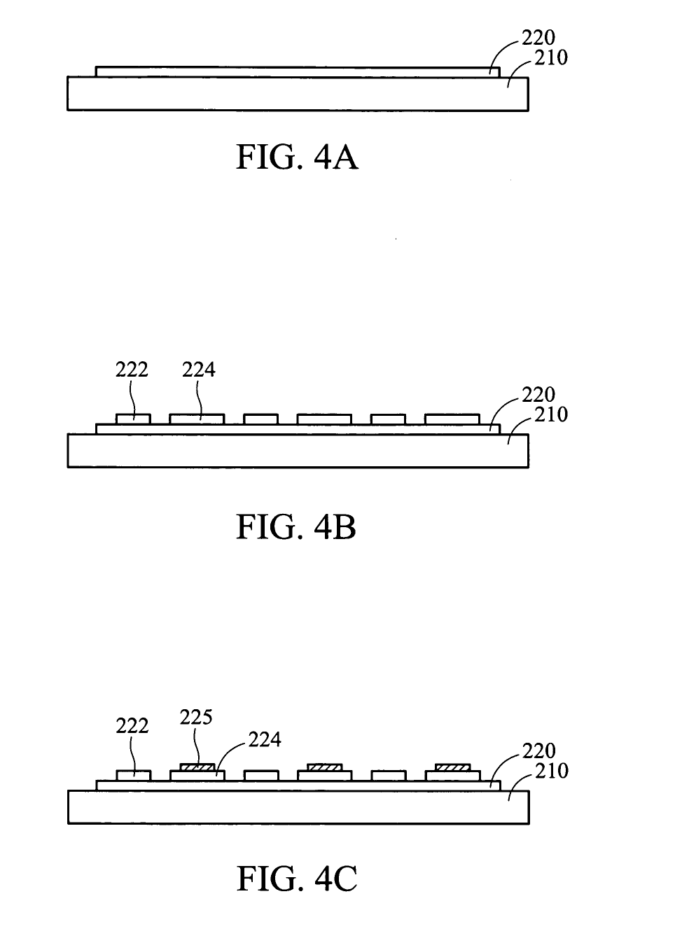

FIGS. 4A-4C are cross sections showing fabrication steps of a substrate structure for a field emission back light unit (FE-BLU) according to an embodiment of the invention. Referring to FIG. 4A, a substrate 210 such as a transparent glass substrate or a flexible substrate is provided. An interfacial layer 220 or formed on the substrate 210. The interfacial layer 220 can prevent spread of subsequent printed electrode paste patterns and improve surface tension of the electrode paste patterns. The contact angle between the electrode paste patterns and the interfacial layer is preferably greater than 35°, more preferably greater than 40°. Any interfacial layer which can increase the contact angle by at least 15° is suitable for preventing spread of the electrode paste pattern.

Referring to FIG. 4B, an electrode patterns including a cathode electrode pattern 224 and a gate line pattern 222 are formed on the interfacial layer 220. For example, a patterned conductive paste layer is screen printed on the interfacial layer 220. Since the difference in wettability between the patterned conductive paste layer and the interfacial layer 220 is apparent, the surface tension of the patterned conductive paste layer on the interfacial layer 220 is strong, resulting in a high contact angle between the patterned conductive paste layer and the interfacial layer 220. Compared with printing a patterned conductive paste layer directly formed on the glass substrate, the contact angle can increase at least 15° due to addition of the interfacial layer.

Referring to FIG. 4C, a carbon nanotube field emitter 225 is formed on the cathode electrode pattern 224. For example, a carbon nanotube paste is screen printed on the cathode electrode pattern 224. The interface between the carbon nanotube paste and the cathode electrode pattern 224 includes a high contact angle to prevent spread of the carbon nanotube paste pattern on the cathode electrode pattern 224. Subsequently, a photo spacer and a continuous rib are formed on the substrate structure. The substrate structure is assembled with a corresponding upper substrate, thus, fabrication of a FED or a FE-BLU is complete.

According to embodiments of the invention, the interfacial layer can be transparent or opaque. The interfacial later can comprises conductive or metallic materials. The interfacial layer and the electrode paste pattern can be co-fired for process simplification. Note that any material which can increase the contact angle at least 15° is suitable for the interfacial layer to prevent spread of the electrode paste patterns.

The interfacial layer can comprise insulating materials, such as SiO₂, SiO_{y}, SiNₓ, SiC, B₂O₃, Al₂O₃, SrBaTiO₃, ZnS, ZrO₂, BST, PZT, HfSiO_{z}, HfO₂, ZnO or Polyimide. The interfacial layer can alternatively comprise Pb, Zn, B, Si, or Bi, or oxides thereof which are sintered at low temperature with high transparency and flatness. Moreover, the interfacial layer can alternatively comprise conductive material such as Ag, Cu, Au, Pd, Pt, CNT, or other electrode materials which can serve as an interface between an electrode and an electrode field emitter. The interfacial layer can alternatively comprise a green tape. The green tape can preferably comprise a silicide, a boride, a metal oxide, a metal nitride, or combination thereof Moreover, the patterned paste layer comprises an emitter paste, phosphor paste, conductor paste, dielectric layer paste, or binder layer paste. For example, the emitter paste may comprise carbon nanotube (CNT), diamond like carbon (DLC), graphite, PdO, or TiO_{W}. The conductor paste may comprise a metal paste (e.g, Ag, Au, Cu, Pt, or Pd), or conducting polymer (e.g., PEDOT or polyaniline). The dielectric paste may comprise SiO₂, SiO_{y}, SiNₓ, SiC, B₂O₃, ZnO, ZnS, ZrO₂, BST, PZT, HfSiO_{z}, HfO₂, or polyimide. The interfacial layer can alternatively comprise a sintered silicon oxide, aluminum oxide, or combinations thereof. Note that a surface improvement process can be performed on the substrate. For example, the interfacial layer can be formed on a sand blasted substrate to remedy a damaged substrate surface to increase contact angle.

Accordingly, the interfacial layer for use in the present invention is not limited to those types described above, and may be of the other types if applicable to the present invention. Several materials with different surface tension and wettability can be chosen to serve as an electrode comprising a high contact angle with an electron field emitter thereon. The straightness and resolution of the screen printing can be improved due to the interfacial layer. Those skilled in the art will appreciate that other substrate structures, such as FE-BLU, CNT-FED structures and plasma display panels (PDP), are also applicable to the invention.

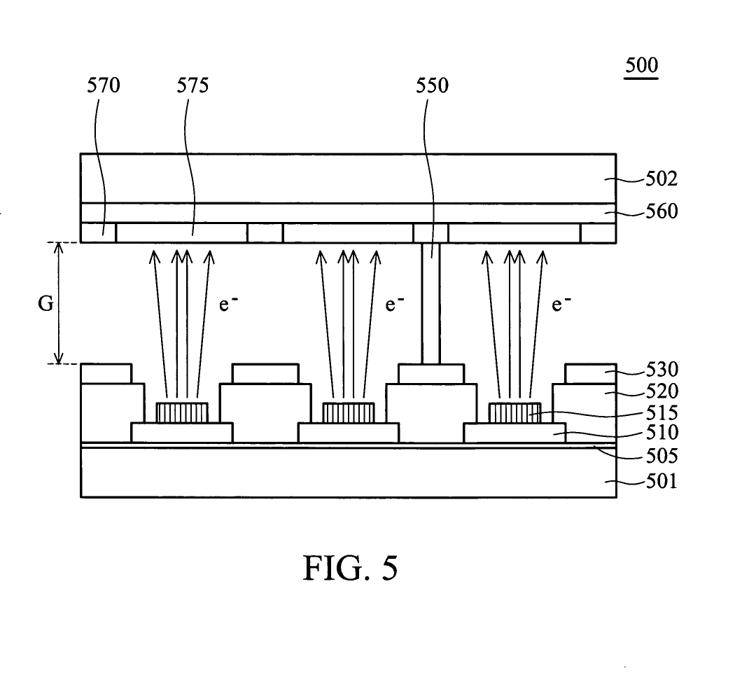

FIG. 5 is a cross section of a CNT-FED device according to an exemplary embodiment of the invention. In FIG. 5, a CNT-FED device 500 comprises a lower substrate 501 and an upper substrate 502. A wall structure 550 or a rib structure separating the lower and upper substrates with a predetermined gap G. The lower and upper substrates are sealed in vacuum. An interfacial layer 505 is disposed on the lower substrate 501. A patterned cathode structure 510 is formed on the interfacial layer 505. A CNT thick film 515 is disposed on the patterned cathode structure 510 to serve as an electron field emitter. A dielectric layer 520 surrounding the patterned cathode structure 510 is disposed on the lower substrate 501. A gate electrode 530 is disposed on the dielectric layer 520.

An anode electrode 560 is disposed on the upper substrate 502. Red, green, and blue fluorescent layers 575 are alternately disposed on the anode electrode 560. A black matrix 570 is disposed between the red, green, and blue fluorescent layers 575.

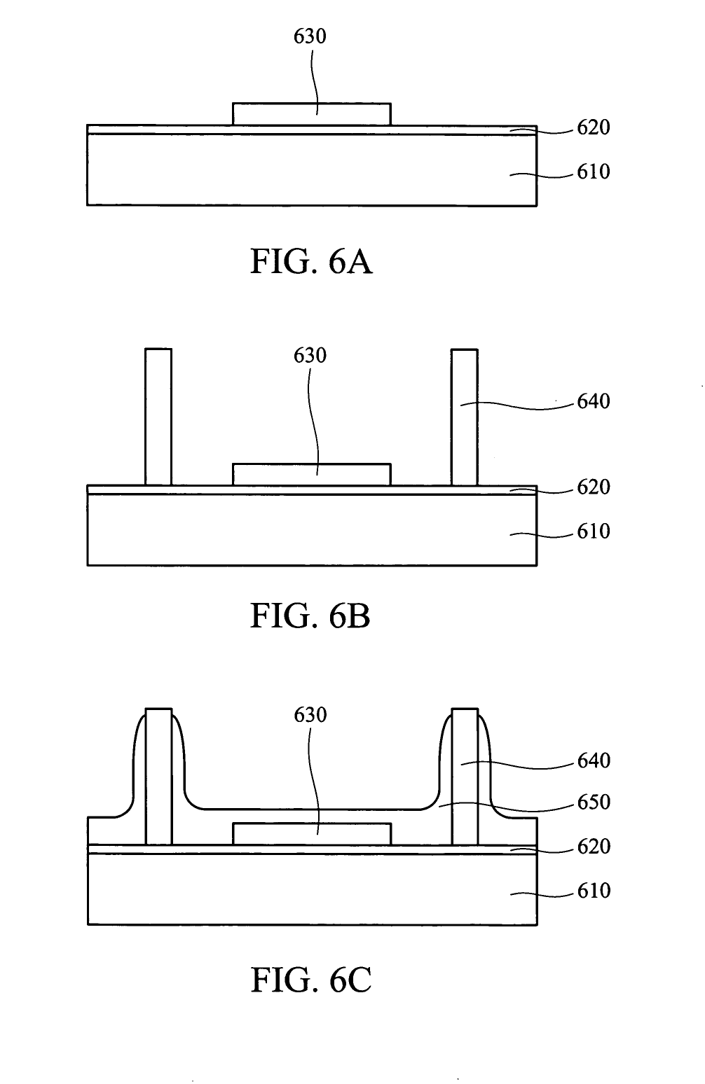

FIGS. 6A-6C are cross sections showing fabrication steps of a substrate structure for a plasma display panel (PDP) according to another embodiment of the invention. Referring to FIG. 5A, a substrate 610 such as a transparent glass substrate or a flexible substrate is provided. An interfacial layer 620 is formed on the substrate 610. The interfacial layer 620 can prevent spread of subsequently printed electrode paste patterns and improve surface tension of the electrode paste patterns. The contact angle between the electrode paste patterns and the interfacial layer is preferably greater than 35°, more preferably greater than 40°. Any interfacial layer which can increase the contact angle by at least 15° is suitable for preventing spread of the electrode paste patterns.

Subsequently, a patterned cathode electrode 630 or data electrode is formed on the interfacial layer 620. For example, a patterned conductive paste layer is screen printed on the interfacial layer 620. Since the difference in wettability between the patterned conductive paste layer and the interfacial layer 620 is apparent, the surface tension of the patterned conductive paste layer on the interfacial layer 620 is strong, resulting in a high contact angle between the patterned conductive paste layer and the interfacial layer 620. Compared with printing a patterned conductive paste pattern layer directly formed on the glass substrate, the contact angle can increase by at least 15° due to addition of the interfacial layer.

Referring to FIG. 6B, a patterned continuous rib structure 640 is formed on the interfacial layer 620 dividing a plurality of pixel regions. For example, a photoresist layer is formed on the interfacial layer 620 and then patterned. Alternatively, the photoresist layer can be directly screen printed on the interfacial layer 620. The interface between the patterned continuous rib structure 640 and the interfacial layer 620 includes a high contact angle to prevent spread of the patterned continuous rib structure 640 on the interfacial layer 620.

Referring to FIG. 6C, a fluorescent layer 650 is formed in each pixel region and covering the patterned cathode electrode 630. The substrate structure is assembled with a corresponding upper substrate, thus, fabrication of a PDP device is complete.

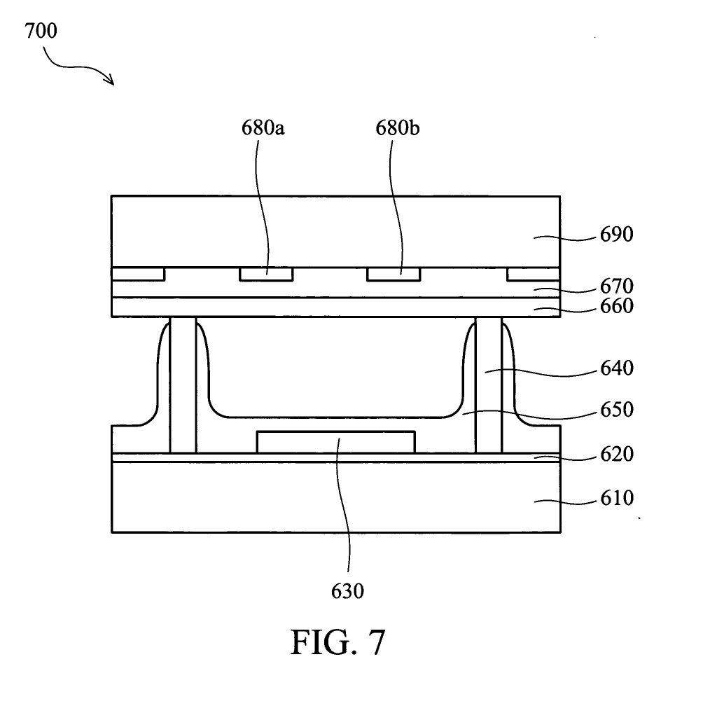

FIG. 7 is a cross section of a PDP device according to another exemplary embodiment of the invention. In FIG. 7, a PDP device 700 comprises a lower substrate 601 and an upper substrate 690. A wall structure 640 or a rib structure separates the lower and upper substrates with a predetermined gap G. The lower and upper substrates are sealed in vacuum or optionally filled some insert gases sequentially. An interfacial layer 620 is disposed on the lower substrate 610. A patterned cathode structure 630 is formed on the interfacial layer 620. A fluorescent layer 650 is formed in each pixel region and covers the patterned cathode electrode 630.

The upper substrate 690 comprises an anode electrode structure including a scan electrode 680a and a sustain electrode 680b. A dielectric layer 670 is disposed on the upper substrate 690 covering the scan electrode 680a and the sustain electrode 680b. A passivation layer 660 such as an MgO layer is disposed on the dielectric layer 670.

Accordingly, the invention is advantageous in that an interfacial layer which can control surface tension between a glass substrate and a patterned paste is formed on a substrate structure. The interfacial layer can change wettability between the glass substrate and the patterned paste. Since the interfacial layer can maintain surface tension between the glass substrate and the patterned paste, the contact angle increases due to the interfacial layer. A high contact angle can prevent the spread of the patterned paste, thereby reducing the interval of line patterns and increasing resolution. Moreover, the interfacial layer can be a highly transparent material to meet requirements for FE-BLU. A sand blast pretreatment may be needed on the glass substrate. The sand blasted glass substrate, however, comprises a low contact angle, leading to spread of the patterned paste. The interfacial layer can be formed on the substrate treated by sand blasting to remedy damage due to the sand blasting.

Compared with printing an electron paste pattern of 50 μm line width and 50 μm line interval on a glass substrate, the contact angle can increase by at least 15° due to addition of the interfacial layer. Moreover, a substrate structure with a high resolution electron paste pattern of 17 μm line width and 83 μm line interval can further be achieved due to addition of the interfacial layer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A substrate structure, comprising:
a substrate;
an interfacial layer disposed on the substrate; and
a patterned paste layer applied on the interfacial layer,
wherein a contact angle of the interface between the patterned paste layer and the interfacial layer exceeds 35 degrees.

2. The substrate structure as claimed in claim 1, wherein the interfacial layer comprises SiO₂, SiO_{y}, SiNₓ, SiC, B₂O₃, Al₂O₃, SrBaTiO₃, ZnS, ZrO₂, BST, PZT, HfSiO_{z}, HfO₂, ZnO or Polyimide.

3. The substrate structure as claimed in claim 1, wherein the interfacial layer comprises Ag, Cu, Au, Pd, Pt, CNT, or other electrode materials.

4. The substrate structure as claimed in claim 1, wherein the interfacial layer comprises a green tape.

5. The substrate structure as claimed in claim 4, wherein the green tape comprises a silicide, a boride, a metal oxide, a metal nitride, or combination thereof.

6. The substrate structure as claimed in claim 1, wherein the patterned paste layer comprises a emitter paste, phosphor paste, conductor paste, dielectric layer paste, or binder layer paste.

7. A substrate structure, comprising:
a substrate;
an interfacial layer disposed on the substrate;
a patterned paste layer applied on the interfacial layer,
a dielectric layer disposed on the patterned paste layer; and
a gate electrode disposed on the dielectric layer,
wherein a contact angle of the interface between the patterned paste layer and the interfacial layer exceeds 35 degrees.

8. The substrate structure as claimed in claim 7, wherein the interfacial layer comprises SiO₂, SiO_{y}, SiNₓ, SiC, B₂O₃, Al₂O₃, SrBaTiO₃, ZnS, ZrO₂, BST, PZT, HfSiO_{z}, HfO₂, ZnO or Polyimide.

9. The substrate structure as claimed in claim 7, wherein the interfacial layer comprises Ag, Cu, Au, Pd, Pt, CNT, or other electrode materials.

10. The substrate structure as claimed in claim 7, wherein the interfacial layer comprises a green tape.

11. The substrate structure as claimed in claim 10, wherein the green tape comprises a silicide, a boride, a metal oxide, a metal nitride, or combination thereof.

12. The substrate structure as claimed in claim 7, wherein the patterned paste layer comprises a emitter paste, phosphor paste, conductor paste, dielectric layer paste, or binder layer paste.

13. A substrate structure, comprising:
a substrate;
an interfacial layer disposed on the substrate;
a patterned paste layer applied on the interfacial layer,
a patterned insulating wall structure disposed on the interfacial layer dividing a plurality of pixel regions; and
a fluorescent layer disposed in each pixel region covering the patterned paste layer,
wherein a contact angle of the interface between the patterned paste layer and the interfacial layer exceeds 35 degrees.

14. The substrate structure as claimed in claim 13, wherein the interfacial layer comprises SiO₂, SiO_{y}, SiNₓ, SiC, B₂O₃, Al₂O₃, SrBaTiO₃, ZnS, ZrO₂, BST, PZT, HfSiO_{z}, HfO₂, ZnO or Polyimide.

15. The substrate structure as claimed in claim 13, wherein the interfacial layer comprises Ag, Cu, Au, Pd, Pt, CNT, or other electrode materials.

16. The substrate structure as claimed in claim 13, wherein the interfacial layer comprises a green tape.

17. The substrate structure as claimed in claim 16, wherein the green tape comprises a silicide, a boride, a metal oxide, a metal nitride, or combination thereof.

18. The substrate structure as claimed in claim 13, wherein the patterned paste layer comprises a emitter paste, phosphor paste, conductor paste, dielectric layer paste, or binder layer paste.

19. A method of fabricating a substrate structure, comprising:
providing a substrate;
performing a surface treatment on the substrate to change the polarity of the substrate;
applying a patterned paste layer on the treated surface of the substrate,
wherein a contact angle of the interface between the patterned paste layer and the treated surface of the substrate exceeds 35 degrees.

20. The method as claimed in claim 19, wherein the step of the surface treatment comprises applying an interfacial layer on the substrate.

21. The method as claimed in claim 19, wherein the interfacial layer comprises SiO₂, SiO_{y}, SiNₓ, SiC, B₂O₃, Al₂O₃, SrBaTiO₃, ZnS, ZrO₂, BST, PZT, HfSiO_{z}, HfO₂, ZnO or Polyimide.

22. The method as claimed in claim 19, wherein the interfacial layer comprises Ag, Cu, Au, Pd, Pt, CNT, or other electrode materials.

23. The method as claimed in claim 19, wherein the interfacial layer comprises a green tape.

24. The method as claimed in claim 23, wherein the green tape comprises a silicide, a boride, a metal oxide, a metal nitride, or combination thereof

25. The substrate structure as claimed in claim 19, wherein the step of surface treatment comprises forming an interfacial layer on the substrate treated by a sand blasting to remedy damage due to the sand blasting.
